(19) United States
(12) Patent Application Publication
(10) Pub. No.: US 2007/0142000 A1
(43) Pub. Date: Jun. 21, 2007

(54) Hybrid polar transmission apparatus for a radio transmission system

(76) Inventor: Stefan Herzinger, Munchen (DE)

Correspondence Address: ESCHWEILER & ASSOCIATES, LLC;NATIONAL CITY BANK BUILDING, 629 EUCLID AVE., SUITE 1000, CLEVELAND, OH, 44114, US

(21) Appl. No.: 11/300,836

(22) Filed: Dec. 15, 2005

(51) Int. Cl. H04B 1/02

(52) U.S. Cl. 455/91

(57) ABSTRACT

The invention relates to a polar transmission apparatus having a polar transformer for transformation of a baseband signal to an amplitude signal and a phase signal. The apparatus includes a frequency synthesizer for production of a radio-frequency signal from the phase signal, having a modulator for amplitude modulation of the radio-frequency signal. The modulation is selectively carried out either by a mixer mixing the radio-frequency signal with the amplitude signal or by an amplifier amplifying the radio-frequency signal and modulating the gain with the amplitude signal.

### FIELD OF THE INVENTION

The invention relates to a hybrid polar transmission apparatus which can be used, for example, in mobile radios. The invention also relates to a method for amplitude modulation of a radio-frequency signal in a polar transmission apparatus.

### BACKGROUND OF THE INVENTION

One primary aim in the development of radio-frequency transmission architectures for mobile radios is to achieve a low power consumption and a high efficiency from the individual circuit components. This allows the mobile radios to be operated for long periods with small and lightweight batteries or rechargeable batteries. High-efficiency transmitters are available for transmitters which use a phase modulation method for modulation. One reason for this is that phase-modulated signals have a constant envelope, so that simple, high-efficiency, non-linear amplifiers can be used.

In order to take account of the increased bandwidth requirement in mobile radios, for example resulting from Internet applications, amplitude modulation is used in addition to phase modulation for, inter alia, the EDGE, UMTS and WLAN mobile radio standards. The information to be transmitted is in this case coded not only in the signal phase but also in the signal amplitude. Since the envelope of a phase-modulated and amplitude-modulated signal is not constant, linear transmitter concepts are required for signal transmission with an accurate phase and amplitude.

Transmitters whose modulation methods include both a phase component and an amplitude component and which are intended to have linear transmission characteristics overall are frequently in the form of polar transmitters. In the case of a polar transmitter, the complex baseband signal is transformed to a polar form, and the amplitude and phase are processed separately. The phase signal is in this case converted to a modulated radio-frequency signal by means of a frequency synthesizer. The radio-frequency signal is then modulated with the amplitude signal.

Both polar transmitters and polar loop transmitters, as well as polar modulators are used as polar transmitters. Each of these polar transmitter concepts has specific advantages and disadvantages when implemented in practice, and these will be explained briefly in the following text.

A polar transmitter is characterized in that the amplitude modulation does not take place until the output stage of the power output stage. A polar transmitter has the advantage that it does not require any power amplifiers operated in a linear form, and that it achieves high output power levels with good efficiency. One disadvantage of a polar transmitter is that the modulation in the power output stage causes amplitude and phase distortion, which are also respectively referred to as AM/AM distortion (AM: amplitude modulation) and AM/PM distortion (PM: phase modulation). The amplitude signal and the phase signal must each be subjected to predistortion in order to compensate for the AM/AM and AM/PM distortion. A very accurate model of the power amplifier is required for this purpose. Furthermore, the parameter fluctuations in the power amplifier must either be very small or must be determined individually, or else modelled, for each individual power amplifier during manufacture. A further disadvantage of polar transmitters is the poor quality of the modulation at low output levels. Furthermore, the necessity to design the power amplifier for the maximum output power results in major disadvantages during operation at low output power levels.

A polar loop transmitter differs from a polar transmitter by having an additional feedback path. The feedback path linearizes the non-linear power amplifier, which is in the form of an amplitude modulator, with respect to the transmission data. The disadvantages of a polar loop transmitter are the complex feedback path, for which a relatively large number of frequency synthesizers are required, as well as the large number of analogue signal processing blocks, which are accurately matched to one another.

In contrast to polar transmitters, the amplitude modulation in a polar modulator is not carried out in the power amplifier but in a mixer connected upstream of the power amplifier. This concept offers the advantage that the modulation can be carried out with high precision even at very low output levels, and thus it is insensitive to fluctuations in the analogue parameters. One disadvantage of the polar modulator concept is that the power amplifier must be operated in a linear form, and thus has a poor efficiency. Furthermore, high output power levels can be achieved only with difficulty during linear operation. In order to achieve high output levels, an additional programmable amplifier (programmable gain amplifier; PGA) or an additional controllable amplifier (variable gain amplifier; VGA) must be provided in the signal path, and these amplifiers are subject to very stringent noise requirements. Furthermore, the output stage, which is operated in a linear form, of a polar modulator transmitter is sensitive to antenna mismatches.

Examples of polar transmitters, polar loop transmitters and polar modulators are illustrated in FIGS. 1 to 3 and will be described further below. The polar transmitters illustrated there have already been introduced in the lecture “A Survey of Next Generation GSM/EDGE Mobile RF Transmitter Architectures” by Stefan Herzinger on 8 Jun. 2003 in the WSB Workshop “Next Generation Transmitter Architecture and Design”, which was held during the “IEEE RFIC 2003 Conference, Philadelphia” in the Pennsylvania Convention Center.

### SUMMARY OF THE INVENTION

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present one or more concepts of the invention in a simplified form as a prelude to the more detailed description that is presented later.

The present invention is directed to a polar transmission apparatus which combines the advantages of a polar transmitter and a polar loop transmitter with those of a polar modulator. The invention also includes a method for amplitude modulation of a radio-frequency signal in a polar transmission apparatus.

The polar transmission apparatus according to the invention, which is designed for a radio transmission system, is used to code the data contained in a baseband signal into a radio-frequency output signal, which is intended for radio transmission. The baseband signal is received by a polar coordinate transformation unit and is converted to polar coordinates; that is to say to an amplitude or magnitude signal and a phase signal. A frequency synthesizer generates a radio-frequency signal from the phase signal or from a signal which is dependent on the phase signal. A modulation unit carries out amplitude modulation of the radio-frequency signal, by modulating the radio-frequency signal with the amplitude signal or with a signal which is dependent on the amplitude signal. The modulated radio-frequency signal is emitted as an output signal at the output of the modulation unit.

One aspect of the invention is that the amplitude modulation can be carried out in two different ways. The radio-frequency signal is selectively modulated either by a mixer or a power amplifier. The mixer carries out the amplitude modulation by mixing the radio-frequency signal with the amplitude signal, or with the signal which is dependent thereon. If the amplitude modulation is carried out by the power amplifier, the radio-frequency signal is amplified, and the gain of the power amplifier is at the same time modulated as a function of the amplitude signal or of the signal which is dependent thereon.

The polar transmission apparatus according to one embodiment of the invention represents a hybrid of a polar modulator and a polar (loop) transmitter. The modulator option which is more advantageous in each case can be selected depending on the circumstances. The invention thus combines the advantages of the two modulator concepts. The additional circuitry complexity which is associated with the combination of the two transmitter architectures is relatively minor, and is far outweighed by the advantages which the refinement of the polar transmission apparatus according to the invention provides.

The power level of the output signals is, in one example, used as the criterion for selection of one of the two modulator options. A control unit uses the output power level to select the modulation type, and controls the modulator unit in an appropriate manner.

In one embodiment of the invention, if the power level of the output signals is above a predetermined threshold value, the power amplifier advantageously carries out the amplitude modulation of the radio-frequency signals, while the mixer modulates the radio-frequency signals for power levels which are lower than the threshold value. The threshold value below which the power amplifier must satisfy all the requirements for a polar modulator can be determined, for example, by measurements or other means.

The feature described above makes it possible to exploit the advantages of the polar transmitter concept at high output power levels and to make use of the polar modulator concept at low output power levels, because this is more advantageous in this situation.

According to another embodiment of the invention, the mixer and the power amplifier are arranged in series downstream from the output of the frequency synthesizer, where the radio-frequency signal is emitted. If the power amplifier is modulating the radio-frequency signal, the mixer is switched to be transparent, that is to say the radio-frequency signal passes through the mixer without being changed. If the mixer is modulating the radio-frequency signal, the power amplifier does not carry out any modulation. By way of example, a constant voltage can be applied to the modulation input of the power amplifier for this purpose. Nevertheless, the power amplifier is used in this case to amplify the radio-frequency signals which have been modulated by the mixer. There is no need to provide any additional power output stage for operation of the polar transmission apparatus as a polar modulator.

In another embodiment of the invention, the polar transmission apparatus comprises a variable-gain amplifier connected in series with the mixer and the power amplifier. When the polar transmission apparatus is being operated as a polar modulator, this amplifier is used to set the transmission level while, in contrast, it is not required when the polar transmission apparatus is being operated as a polar (loop) transmitter, and its gain can accordingly be reduced. Either a programmable amplifier (PGA) or a controllable amplifier (VGA) may be used as the amplifier according to the invention.

Since the mixer and the amplifier are used only at low power levels and, furthermore, each need cover only a portion of the level dynamic range, they have to satisfy only minor requirements and can be implemented readily in circuitry. Furthermore, the chip area which is occupied by the mixer and the amplifier is relatively small owing to the reduced dynamic range. These are advantageous features of the present invention.

One embodiment of the invention includes a switching unit which feeds the amplitude signal or the signal which is dependent thereon to a modulation input of the power amplifier when modulation is being carried out by means of the power amplifier, and feeds the amplitude signal or the signal which is dependent thereon to one input of the mixer when the modulation is being carried out by means of the mixer. The switching unit is advantageously controlled by the control unit. The switching unit allows switching between the two modulation types.

When the polar transmission apparatus according to the invention is being operated as a polar modulator, the power amplifier is operated linearly. In contrast, the power amplifier is preferably operated in a switching mode (switched mode) when the polar transmission apparatus is being operated as a polar (loop) transmitter. In the switching mode, the output stage transistor is switched on and off as completely as possible at the radio-frequency clock rate. This type of operation is particularly suitable for achieving high radio-frequency power levels with high efficiency. The modulation can in this case be carried out, for example, by variation of the supply voltage for the output stage transistor.

The various types of operation of the power amplifier and the switching between the types of operation of the power amplifier are achieved in a simple manner by optimizing the power amplifier for production of the switching mode. This means that the power amplifier is operated at high input levels in the switching mode. As soon as the input level is low enough, however, the power amplifier automatically becomes linear. In consequence, the power amplifier automatically operates in the respectively required type of operation.

The radio-frequency signal which is produced by the frequency synthesizer is modulated in one example with the phase signal or with the signal which is dependent thereon by phase modulation.

The mixer, in one example, comprises a Gilbert mixer.

The polar transmission apparatus according to one embodiment of the invention comprises a hybrid transmission apparatus, which combines a polar modulator with a polar transmitter or a polar modulator with a polar loop transmitter. In one example, if the polar transmission apparatus operates as a polar transmitter at high output power levels, an amplitude predistorter or a phase predistorter is connected in the signal path of the amplitude signal or of the phase signal, respectively. The predistorters are used to compensate for the amplitude or phase distortion that is caused by the modulation by the power amplifier.

Since the amplitude predistorter and the phase predistorter are not required for modulation by means of the mixer, they are deactivated at low output power levels. The amplitude predistorter and the phase predistorter are generally designed using digital technology, and can easily be deactivated.

If the polar transmission apparatus according to the invention simulates a polar loop transmitter at high output power levels, a feedback path is provided which is fed by the output signal and produces an intermediate-frequency signal by down-mixing of the output signal to an intermediate frequency. An amplitude comparison unit compares the amplitude of the amplitude signal that is produced by the polar coordinate transformation unit with the amplitude of the intermediate-frequency signal. Furthermore, a phase comparison unit compares the phase of the phase signal that is produced by the polar coordinate transformation unit with that of the intermediate-frequency signal.

By way of example, the amplitude signals are obtained by means of diode detectors, while the phase signals are produced, for example, by means of limiters.

In another embodiment of the invention, a method for amplitude modulation of a radio-frequency signal is provided and used in a polar transmission apparatus in a radio transmission system. The method comprises (a) transformation of a baseband signal to an amplitude signal and a phase signal, (b) production of a radio-frequency signal as a function of the phase signal or of a signal which is dependent thereon, and (c) production of an output signal by amplitude modulation of the radio-frequency signal with the amplitude signal or a signal which is dependent thereon.

In accordance with the method according to the invention, the modulation of the radio-frequency signal in act (c) is carried out selectively either by mixing the radio-frequency signal with the amplitude signal or with the signal which is dependent thereon, or by the radio-frequency signal being amplified by means of a power amplifier, and by the gain being modulated as a function of the amplitude signal or of the signal which is dependent thereon.

In the same way as the polar transmission apparatus according to the invention, the method according to the invention combines the modulation method for a polar modulator with the modulation method for a polar (loop) transmitter, and makes use of the respective advantages.

To the accomplishment of the foregoing and related ends, the invention comprises the features hereinafter fully described and particularly pointed out in the claims. The following description and the annexed drawings set forth in detail certain illustrative aspects and implementations of the invention. These are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The invention will be explained in the following text using examples and with reference to the drawings, in which:

FIG. 1 is a block diagram illustrating a polar transmitter according to the prior art;

FIG. 2 is a block diagram illustrating a polar loop transmitter according to the prior art;

FIG. 3 is a block diagram illustrating a polar modulator according to the prior art;

FIG. 4 is a block diagram illustrating a polar transmission circuit, as a first exemplary embodiment of the polar transmission apparatus according to the invention; and

FIG. 5 is a block diagram illustrating a polar transmission circuit, as a second exemplary embodiment of the polar transmission apparatus according to the invention.

### DETAILED DESCRIPTION OF THE INVENTION

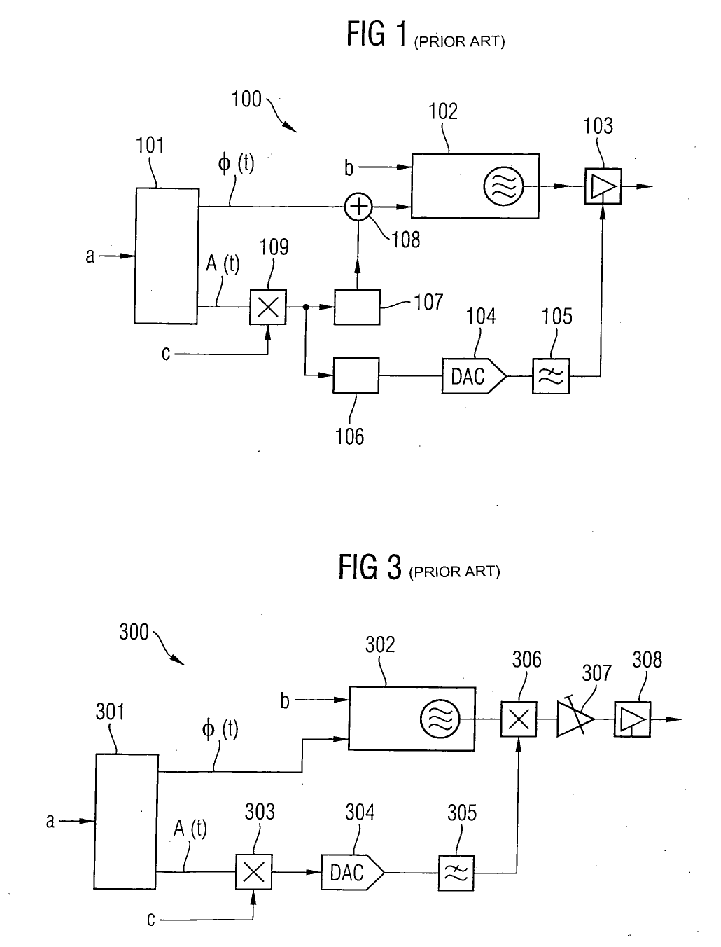

FIG. 1 shows an example of a conventional polar transmitter. The data to be transmitted, which in FIG. 1 enters the polar transmitter 100 as a binary data stream a, is converted in a processing unit 101 to a complex-value symbol sequence, and is converted by a pulse shaping filter to a complex baseband signal. The complex baseband signal is then transformed to the polar form, in which the variable φ(t) represents the phase signal, and the variable A(t) represents the amplitude or magnitude signal.

A step-up converter 102 which, for example, is based on a PLL (phase locked loop) produces an analogue radio-frequency signal which is modulated by the phase signal φ(t). A channel word b is supplied to the step-up converter 102 in order to adjust the PLL. The radio-frequency signal is fed to a power amplifier 103, in whose output stage the radio-frequency signal is amplitude-modulated with the aid of the amplitude signal. For this purpose, the digital amplitude signal will previously have been converted by a digital/analogue converter 104 to an analogue signal, which is then filtered by means of a noise filter 105 in order to reduce the quantization noise. The analogue amplitude signal obtained in this way is supplied to a modulation input of the power amplifier 103, in order to amplitude-modulate the radio-frequency signal as a function of the analogue amplitude signal. The power amplifier 103 is operated in the switching mode, for amplitude modulation. In the switching mode, the output stage transistor is switched on and off as completely as possible at the radio-frequency clock rate. The modulation can in this case, by way of example, be carried out by variation of the supply voltage to the output stage transistor. The output signal which is emitted at the output of the power amplifier 103 is transmitted via an antenna, which is not illustrated in FIG. 1.

Since the modulation in the power amplifier 103 causes AM/AM as well as AM/PM distortion, both the digital phase signal φ(t) and the digital amplitude signal A(t) are subjected to predistortion, in order to compensate for the distortion. For this purpose, an AM/AM predistorter 106 is connected in the signal path of the digital amplitude signal A(t). Furthermore, a predistortion value for the digital phase signal φ(t) is obtained from the digital amplitude signal A(t) by means of an AM/PM predistorter 107, and is superimposed on the digital phase signal φ(t) by means of an adder 108.

A mixer 109 is connected in the signal path of the digital amplitude signal A(t) in order to supply a ramping signal c and in order to control the signal power. The ramping signal c results in the output signal power level being stepped up in a controlled manner at the start of a transmission burst at the output of the power amplifier 103, and being stepped down in a corresponding manner at the end of a transmission burst.

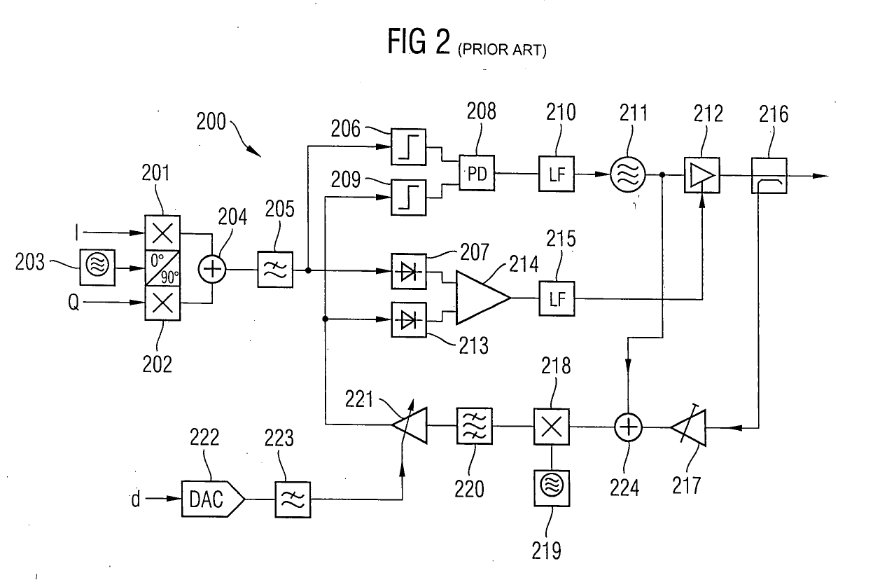

FIG. 2 illustrates one example of a conventional polar loop transmitter. The complex baseband signal is in this case in the form of an I signal and a Q signal. The I and Q signals are mixed by means of the mixers 201 and 202 with two orthogonal signals which are produced by a local oscillator 203, and are then added by an adder 204. The signals then pass through a low-pass filter 205. In order to break the signals that are emitted at the output of the low-pass filter 205 down into polar coordinates, the output of the low-pass filter 205 is connected to the inputs of a limiter 206 and of a diode detector 207. The limiter 206 produces phase information relating to its input signal at its output while, in contrast, the amplitude of the input signal to the diode detector 207 can be tapped off at its output. The nominal phase information which is produced by the limiter 206 is compared in a phase detector 208 with actual phase information, produced by a limiter 209, by forming the difference between the phase angles. The input to the limiter 209 is in this case connected to a feedback path which will be described further below. The phase detector 208 is followed by a low-pass filter 210 and a voltage controlled oscillator (VCO) 211. A power amplifier 212, which is operated as an amplitude modulator, has its input connected to the output of the voltage controlled oscillator 211. The power amplifier 212 has a modulation input, at which an amplitude modulation signal is supplied to the power amplifier 212. The amplitude modulation signal is produced by nominal amplitude information being produced at the output of the diode detector 207, and by actual amplitude information being produced at the output of a diode detector 213. The diode detector 213 is in this case connected to the same feedback path as the limiter 209. The nominal and the actual amplitude information are fed to the two inputs of a differential amplifier 214, which emits the difference between the nominal and the actual amplitude information. This difference value is passed through a low-pass filter 215, and is then fed to the modulation input of the power amplifier 212. The power amplifier 212 is operated in the switching mode, for amplitude modulation of the radio-frequency signal that is produced by the voltage controlled oscillator 211. The output signal which is produced at the output of the power amplifier 212 is transmitted via an antenna, which is not illustrated in FIG. 2.

The output signal is also fed by means of a coupling element 216, which is arranged downstream from the output of the power amplifier 212, to the feedback path that has already been mentioned above. The feedback path has a programmable amplifier 217, which attenuates the output signal. The programmable amplifier 217 is followed by a mixer 218 which down-mixes the attenuated output signal to an intermediate frequency, by means of a signal which is produced by a local oscillator 219. The output of the mixer 218 is connected to the input of a bandpass filter 220, which is in turn followed by a controllable amplifier 221. A ramping signal d, which has previously been converted by means of a digital/analogue converter 222 to an analogue signal and has been filtered by means of a noise filter 223, is supplied to the control input of the controllable amplifier 221. The output of the controllable amplifier 221 is connected to the inputs of the limiter 209 and of the diode detector 213.

The polar loop transmitter 200 has a further feedback path, which supplies the output signal from the voltage controlled oscillator 211 via an adder 224 to the mixer 218. This feedback path is required for stabilization of the circuit on start-up of the polar loop transmitter 200. The power amplifier 212 is switched off during the stabilization process, in order to prevent any signals from being transmitted from the antenna.

By way of example, FIG. 3 shows a conventional polar modulator 300. Large parts of the polar modulator 300 correspond to the polar transmitter 100 shown in FIG. 1. This applies in particular to the processing unit 301, to the step-up converter 302, to the mixer 303, to the digital/analogue converter 304 and to the noise filter 305. These components each have a corresponding component in the polar transmitter 100.

The major difference between the polar modulator 300 and the polar transmitter 100 is that, in the case of the polar modulator 300, the amplitude modulation of the radio-frequency signal which is obtained from the phase signal φ(t) takes place in a mixer 306. In this case, the radio-frequency signal is multiplied by the amplitude signal. The amplitude-modulated radio-frequency signal then passes through a programmable or controllable amplifier 307, and is only then passed to the power amplifier 308. The power amplifier 308 does not carry out any modulation. In contrast to the power amplifier 103 in the polar transmitter 100, the power amplifier 308 must be operated in a linear form.

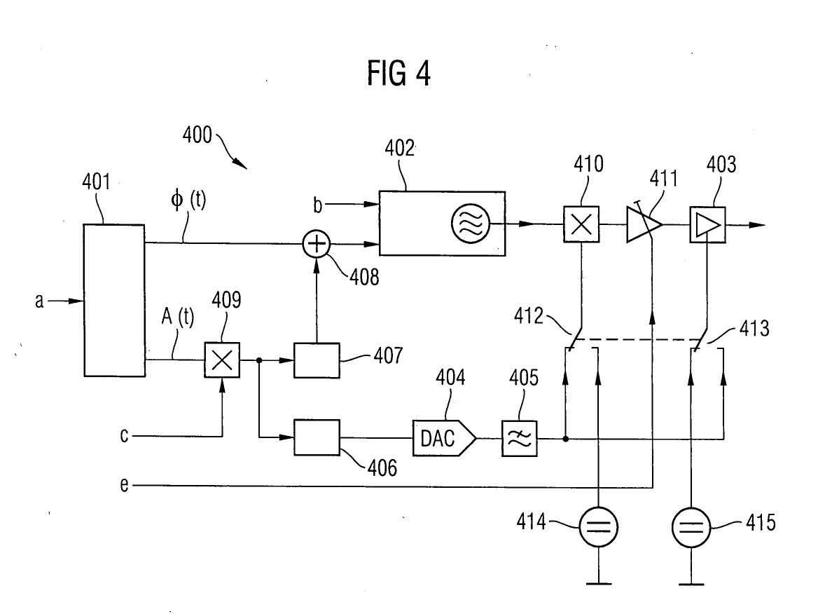

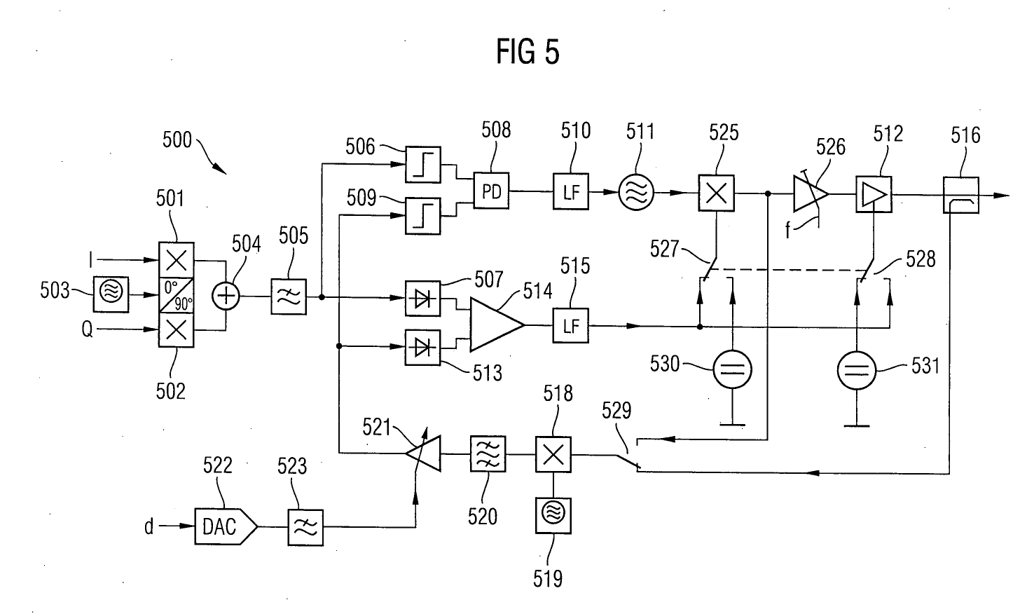

FIG. 4 shows a polar transmission circuit 400 as a first exemplary embodiment of the polar transmission apparatus according to the invention. The polar transmission circuit 400 represents a combination of a polar transmitter and a polar modulator. Large parts of the polar transmission circuit 400 are based on the polar transmitter 100 illustrated in FIG. 1. The polar transmission circuit 400 thus contains components which correspond to the components with the reference symbols 101 to 109 in the polar transmitter 100. In detail, these are a processing unit 401, a step-up converter 402, a power amplifier 403, a digital/analogue converter 404, a noise filter 405, an AM/AM predistorter 406, an AM/PM predistorter 407, an adder 408 and a mixer 409. The components mentioned are connected to one another, with the exception of the power amplifier 403, in a similar fashion as in the polar transmitter 100.

In contrast to the polar transmitter 100, the polar transmission circuit 400 additionally contains a mixer 410, a programmable amplifier (PGA) 411, two switching units 412 and 413 as well as two DC voltage sources 414 and 415. In this case, one input of the mixer 410 is connected to the output of the step-up converter 402. The other input of the mixer 410 can either be connected via the switching unit 412 to the output of the noise filter 405, or can have a constant voltage applied to it, which is produced by the DC voltage source 414. The programmable amplifier 411 and the power amplifier 403 are arranged in series downstream from the output of the mixer 410. The programmable amplifier 411 has a programming input, via which it is supplied with a programming word e in order to adjust its gain. The modulation input of the power amplifier 403 can either be connected via the switching unit 413 to the output of the noise filter 405, or can have a constant voltage applied to it, which is produced by the DC voltage source 415.

Furthermore, the polar transmission circuit 400 contains a control unit, which is not illustrated in FIG. 4 but is used to control the switching units 412 and 413. The switch positions of the switching units 412 and 413 are coupled to one another.

The method of operation of the polar transmission circuit 400 is as follows. When the output levels are low and are below a specific threshold value, the control unit sets the switching unit 412 such that the analogue amplitude signals which are emitted from the noise filter 405 are mixed in the mixer 410 with the analogue radio-frequency signal that is generated by the step-up converter 402. The modulation input of the power amplifier 403 is in this case disconnected from the output of the noise filter 405, so that no modulation is carried out in the power amplifier 403. Furthermore, in this case, no predistortion is carried out by the AM/AM predistorter 406 or the AM/PM predistorter 407. The AM/AM predistorter 406 and the AM/PM predistorter 407 are designed using conventional digital technology, and can be deactivated by software.

This means that the polar transmission circuit 400 is operated as a polar modulator at low output levels. The amplitude modulation is in this case carried out in the mixer 410. The modulated radio-frequency signal is amplified in the programmable amplifier 411 and in the power amplifier 403, and is transmitted via the antenna. In this case, the power amplifier 403 is operated in a linear form. When the constant voltage that is produced by the DC voltage source 415 is applied to the power amplifier 403, this suitably fixes the operating point of the transmission stage. The operation of the polar transmission circuit 400 at low output levels corresponds to the operation of the polar modulator 300 that is illustrated in FIG. 3.

At high output levels, which are above the predetermined threshold value, the switch positions of the switching units 412 and 413 are switched by the control unit. In this case, the amplitude signal which is emitted from the noise filter 405 is no longer applied to the mixer 410, but to the modulation input of the power amplifier 403. Furthermore, the AM/AM predistorter 406 and the AM/PM predistorter 407 are activated, and the gain of the programmable amplifier 411 is reduced. The mixer 410 is in this case switched to be transparent, so that it does not carry out any modulation. The amplitude modulation is carried out exclusively in the power amplifier 403, which need no longer be operated in a linear form but, for example, is operated in the switching mode. The circuit diagram of the polar transmitter 100 as shown in FIG. 1 can be used as an equivalent circuit for the polar transmission circuit 400 at high output levels.

FIG. 5 shows a polar transmission circuit 500 as a second exemplary embodiment of the polar transmission apparatus according to the invention. The polar transmission circuit 500 represents a combination of a polar loop transmitter and a polar modulator. Large parts of the polar transmission circuit 500 are based on the polar loop transmitter 200 that is illustrated in FIG. 2. The polar transmission circuit 500 therefore contains components which correspond to components with the reference symbols 201 to 223 in the polar loop transmitter 200. In detail, these are two mixers 501 and 502, a local oscillator 503, an adder 504, a low-pass filter 505, a limiter 506, a diode detector 507, a phase detector 508, a limiter 509, a low-pass filter 510, a voltage controlled oscillator 511, a power amplifier 512, a diode detector 513, a differential amplifier 514, a low-pass filter 515, a coupling element 516, a mixer 518, a local oscillator 519, a bandpass filter 520, a controllable amplifier 521, a digital/analogue converter 522 and a noise filter 523. The components which have been mentioned are connected to one another, with the exception of the power amplifier 512 and the coupling element 516, in a similar way as in the polar loop transmitter 200.

In contrast to the polar loop transmitter 200, the polar transmission circuit 500 additionally contains a mixer 525, a programmable amplifier (PGA) 526, three switching units 527, 528 and 529, as well as two DC voltage sources 530 and 531. One input of the mixer 525 is connected to the output of the voltage controlled oscillator 511. The other input of the mixer 525 can either be connected via the switching unit 527 to the output of the low-pass filter 515, or can have a constant voltage applied to it, which is produced by the DC voltage source 530. The programmable amplifier 526, the power amplifier 512 and the coupling element 516 are arranged in series downstream from the output of the mixer 525. The programmable amplifier 526 has a programming input via which it is supplied with a programming word f in order to adjust its gain. The modulation input of the power amplifier 512 can either be connected via the switching unit 528 to the output of the low-pass filter 515, or can have a constant voltage applied to it, which is produced by the DC voltage source 531. The output of the mixer 525 can be connected to the input of the mixer 518 via the switching unit 529. When the switching unit 529 is in the other switch position, the coupling element 516 is connected to the input of the mixer 518.

The polar transmission circuit 500 also contains a control unit, which is not illustrated in FIG. 5 but is used to control the switching units 527, 528 and 529. The switch positions of the switching units 527 and 528 are coupled to one another.

The method of operation of the polar transmission circuit 500 is as follows. When the output levels are low and are below a specific threshold value, the control unit sets the switching unit 527 such that the analogue amplitude difference signals which are emitted from the low-pass filter 515 are mixed in the mixer 525 with the analogue radio-frequency signal which is generated by the voltage controlled oscillator 511. The modulation input of the power amplifier 512 is in this case decoupled from the output of the low-pass filter 515, so that no modulation is carried out in the power amplifier 512.

When the output levels are low, the polar transmission circuit 500 is operated as a polar modulator. The amplitude modulation in this case takes place in the mixer 525. The modulated radio-frequency signal is then amplified in the programmable amplifier 526 and in the power amplifier 512, and is transmitted via the antenna. In this case, the power amplifier 512 is operated in a linear form.

At high output levels, which are above the predetermined threshold value, the switch positions of the switching units 527 and 528 are switched by the control unit. In this case, the amplitude difference signal which is emitted from the low-pass filter 515 is no longer applied to the mixer 525, but is applied to the modulation input of the power amplifier 512. Furthermore, the gain of the programmable amplifier 526 is reduced. In this case, the mixer 525 is switched to be transparent, so that it does not carry out any modulation. The amplitude modulation is carried out exclusively in the power amplifier 512, which also need no longer be operated in a linear form, but is operated, for example, in the switching mode. The circuit diagram of the polar loop transmitter 200 which is shown in FIG. 2 can be used as an equivalent circuit for the polar transmission circuit 500 at high output levels.

The power amplifiers 403 and 512 in the polar transmission circuits 400 and 500 are, in one embodiment of the invention, optimized during their production for operation in the switching mode. As soon as their input level is sufficiently low, they automatically operate in the linear mode, that is to say approximately 5-10 dB below the 1 dB compression point, depending on the type of modulation. Before implementation, measurements may be carried out to determine the input level from which the power amplifiers 403 and 512 satisfy all of the requirements for linear operation. This input level may be used as the threshold value at which switching takes place between the polar modulator mode and the polar (loop) transmitter mode.

While the invention has been illustrated and described with respect to one or more implementations, alterations and/or modifications may be made to the illustrated examples without departing from the spirit and scope of the appended claims. In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising”. In addition, the term “exemplary” as utilized herein merely means an example, rather than the best.

1. A polar transmission apparatus for a radio transmission system, comprising:
a polar coordinate transformation unit configured to transform a baseband signal to an amplitude signal and a phase signal;
a frequency synthesizer configured to produce a radio-frequency signal as a function of the phase signal or of a signal which is dependent thereon; and
a modulation unit configured to produce an output signal by amplitude modulation of the radio-frequency signal with the amplitude signal or a signal which is dependent thereon, wherein the modulation unit comprises:
a mixer; and
a power amplifier,
wherein the modulation unit is configured to selectively amplitude modulate the radio-frequency signal by the mixer mixing the radio-frequency signal with the amplitude signal or with the signal which is dependent thereon, or by the power amplifier amplifying the radio-frequency signal and modulating the gain as a function of the amplitude signal or of the signal which is dependent thereon.

2. The polar transmission apparatus of claim 1, further comprising a control unit configured to control the modulation unit as a function of a power level of the output signal to dictate whether the amplitude modulation of the radio-frequency signal is carried out by the mixer or by the power amplifier.

3. The polar transmission apparatus of claim 2, wherein if the power level of the output signal is above a predetermined threshold value, the control unit generates a control signal to dictate that the power amplifier carry out the amplitude modulation of the radio-frequency signal, and if the power level of the output signal is below the predetermined threshold value, the control unit generates a control signal to dictate that the mixer carry out the amplitude modulation of the radio-frequency signal.

4. The polar transmission apparatus of claim 1, wherein the mixer and the power amplifier are connected in a signal path of the radio-frequency signal, and wherein if the radio-frequency signal is amplitude-modulated by the power amplifier, the radio-frequency signal passes through the mixer unchanged, and if the radio-frequency signal is amplitude-modulated by the mixer, the gain of the power amplifier is not modulated.

5. The polar transmission apparatus of claim 4, further comprising a variable-gain amplifier connected in the signal path of the radio-frequency signal.

6. The polar transmission apparatus of claim 1, further comprising a switching unit configured to feed the amplitude signal or the signal which is dependent thereon to a modulation input of the power amplifier if the amplitude modulation of the radio-frequency signal is carried out by the power amplifier, and configured to feed the amplitude signal or the signal which is dependent thereon to a mixer input of the mixer if the radio-frequency signal is amplitude-modulated by the mixer.

7. The polar transmission apparatus of claim 1, wherein the power amplifier is operated in a linear mode if the radio-frequency signal is amplitude-modulated by the mixer.

8. The polar transmission apparatus of claim 1, wherein the power amplifier is operated in a switching mode if the radio-frequency signal is amplitude-modulated by the power amplifier.

9. The polar transmission apparatus of claim 1, wherein the radio-frequency signal produced by the frequency synthesizer is modulated with the phase signal or with the signal which is dependent thereon.

10. The polar transmission apparatus of claim 1, further comprising:
an amplitude predistorter configured to provide at least partial compensation for any amplitude distortion caused by the amplitude modulation of the radio-frequency signal by the power amplifier; and
a phase predistorter configured to provide at least partial compensation for any phase distortion caused by the amplitude modulation of the radio-frequency signal by the power amplifier.

11. The polar transmission apparatus of claim 10, wherein the amplitude predistorter and the phase predistorter are deactivated during modulation of the radio-frequency signal by the mixer.

12. The polar transmission apparatus of claim 1, further comprising:
a feedback path fed by the output signal or by a signal which is dependent thereon, and configured to produce an intermediate-frequency signal by down-mixing the output signal or the signal which is dependent thereon to an intermediate frequency;
an amplitude comparison unit configured to produce a signal which is dependent on the amplitude signal, by means of amplitude comparison of the amplitude signal with the intermediate-frequency signal; and
a phase comparison unit configured to produce a signal which is dependent on the phase signal by phase comparison of the phase signal with the intermediate-frequency signal.

13. The polar transmission apparatus of claim 12:
wherein that the polar coordinate transformation unit comprises a first diode detector having an input to which the baseband signal is supplied, and a second diode detector having an input to which the intermediate-frequency signal is supplied, and
wherein the outputs of the first and second diode detectors are connected to respective inputs of the amplitude comparison unit.

14. The polar transmission apparatus of claim 12:
wherein the polar coordinate transformation unit comprises a first limiter having an input to which the baseband signal is supplied, and a second limiter having an input to which the intermediate-frequency signal is supplied, and
wherein the outputs of the first and second limiters are connected to a respective inputs of the phase comparison unit.

15. A method for amplitude modulation of a radio-frequency signal in a polar transmission apparatus, comprising:
(a) transforming a baseband signal to an amplitude signal and a phase signal;
(b) producing a radio-frequency signal as a function of the phase signal or of a signal which is dependent thereon; and
(c) producing an output signal by amplitude modulation of the radio-frequency signal with the amplitude signal or a signal which is dependent thereon,
wherein the amplitude modulation of the radio-frequency signal is carried out selectively either by mixing the radio-frequency signal with the amplitude signal or with the signal which is dependent thereon, or by the radio-frequency signal being amplified by a power amplifier, and by the gain being modulated as a function of the amplitude signal or of the signal which is dependent thereon.

16. The method of claim 15, wherein the manner in which the amplitude modulation of the radio-frequency signal is carried out depends on a power level of the output signal.

17. The method of claim 16, wherein the selective amplitude modulation comprises:
employing the power amplifier to perform the amplitude modulation of the radio-frequency signal if the power level of the output signal is above a predetermined threshold value, and
mixing the radio-frequency signal with the amplitude signal of with the signal which is dependent thereon if the power level of the output signal is below the predetermined threshold value.

18. The method of claim 15, wherein the power amplifier is operated in a linear mode if the radio-frequency signal is amplitude-modulated by mixing with the amplitude signal or with the signal which is dependent thereon.

19. The method of claim 15, wherein the power amplifier is operated in a switching mode when the radio-frequency signal is amplitude-modulated by the power amplifier.

20. The method of claim 15, wherein the radio-frequency signal which is produced in act (b) is modulated with the phase signal or with the signal which is dependent thereon.

21. The method of claim 15, further comprising:
predistorting the amplitude signal before carrying out the act (c) for at least partial compensation for any amplitude distortion which is caused by the amplitude modulation of the radio-frequency signal by the power amplifier; and
predistorting the phase signal before carrying out the act (b) for at least partial compensation for any phase distortion which is caused by the amplitude modulation of the radio-frequency signal by the power amplifier.

22. The method of claim 21, further comprising not distorting the amplitude signal and the phase signal if the radio-frequency signal is amplitude-modulated by mixing with the amplitude signal or with the signal which is dependent thereon.

23. The method of claim 15, further comprising:
down-mixing an output signal or a signal which is dependent thereon to an intermediate-frequency signal in a feedback path;
wherein a signal that is dependent on the amplitude signal is produced by amplitude comparison of the amplitude signal with the intermediate-frequency signal, and
wherein a signal that is dependent on the phase signal is produced by phase comparison of the phase signal with the intermediate-frequency signal.
